(19) United States
(12) Patent Application Publication
(10) Pub. No.: US 2026/0341235 A1
(43) Pub. Date: Oct. 29, 2026

(54) DISPLAY DEVICE AND ELECTRONIC DEVICE INCLUDING THE SAME

(71) Applicant: Samsung Display Co., Ltd., Yongin-Si (KR)

(72) Inventors: WOOMI BAE, Yongin-si (KR); HYOJIN LEE, Yongin-si (KR)

(21) Appl. No.: 19/640,644

(22) Filed: Apr. 7, 2026

(30) Foreign Application Priority Data
Apr. 23, 2025 (KR) 10-2025-0053128

(51) Int. Cl. G09G 3/3291

(52) U.S. Cl. CPC G09G 3/3291; G09G 2310/027; G09G 2310/0291; G09G 2330/021

(57) ABSTRACT

Disclosed is a display device which includes a display panel that includes a plurality of pixels and displays an image in units of a driving frame, a data driver that applies data voltages to the plurality of pixels, and a driving controller that controls driving of the data driver. The plurality of pixels includes first pixels arranged in a first direction, and second pixels arranged in the first direction and adjacent to the first pixels in a second direction intersecting the first direction. The driving frame includes a first period during which the data voltages are applied to the first pixels, and a second period during which the data voltages are applied to the second pixels, and a duration of the first period is shorter than a duration of the second period.

### CROSS-REFERENCE TO RELATED APPLICATIONS

This application claims priority under 35 U.S.C. § 119 to Korean Patent Application No. 10-2025-0053128 filed on Apr. 23, 2025, in the Korean Intellectual Property Office, the disclosures of which are incorporated by reference herein in their entireties.

### BACKGROUND

Embodiments of the present disclosure described herein relate to a display device and an electronic device including the same, and more particularly, relate to a display device capable of reducing power consumption and an electronic device including the same.

A light emitting display device among display devices displays an image by using a light emitting diode which generates a light through the recombination of electrons and holes. The light emitting display device provides low power consumption and also supports a fast response speed.

The display device includes a display panel which displays an image, a gate driver which sequentially supplies scan signals to scan lines included in the display panel, and a data driver which supplies data signals to data lines included in the display panel.

### SUMMARY

Embodiments of the present disclosure provide a display device capable of reducing power consumption and an electronic device including the same.

According to an embodiment, a display device includes a display panel that includes a plurality of pixels and displays an image in units of a driving frame, a data driver that applies data voltages to the plurality of pixels, and a driving controller that controls driving of the data driver. The plurality of pixels includes first pixels arranged in a first direction, and second pixels arranged in the first direction and adjacent to the first pixels in a second direction intersecting the first direction. The driving frame includes a first period during which the data voltages are applied to the first pixels, and a second period during which the data voltages are applied to the second pixels, and a duration of the first period is shorter than a duration of the second period.

The plurality of pixels is electrically connected to a plurality of channels, and a number of channels, through which the data voltages are applied to the plurality of pixels during the first period, from among the plurality of channels is smaller than a number of channels, through which the data voltages are applied to the plurality of pixels during the second period, from among the plurality of channels.

The plurality of channels includes first channels electrically connected to the first pixels and a portion of the second pixels, and second channels electrically connected to a remaining portion of the second pixels, the data voltages are applied to the first pixels through the first channels during the first period, and the data voltages are applied to the second pixels through the first channels and the second channels during the second period.

The data driver includes a plurality of output blocks. The first channels are connected to a first output block among the plurality of output blocks, and the second channels are connected to a second output block among the plurality of output blocks.

During the first period and the second period, the first output block is turned on in response to a first enable signal, and during the second period, the second output block is turned on in response to a second enable signal.

The data driver includes a latch part that receives an image data signal from the driving controller and latches the image data signal, a digital-analog converter that converts the image data signal into the data voltages, and an output buffer part that outputs the data voltages. The output buffer part includes the plurality of output blocks.

The display panel includes a display area in which the plurality of pixels is disposed. The display area includes a first display area in which the first pixels and the portion of the second pixels are disposed, and a second display area in which the remaining portion of the second pixels are disposed.

The data voltages are applied to the plurality of pixels disposed in the first display area through the first channels, and the data voltages are applied to the plurality of pixels disposed in the second display area through the first channels and the second channels.

The driving controller receives an input control signal including a vertical synchronization signal and a horizontal synchronization signal, the vertical synchronization signal determines a period of the driving frame, and the horizontal synchronization signal determines enable time points of the first period and the second period.

A period of the horizontal synchronization signal is variable during the driving frame.

A duty ratio of the horizontal synchronization signal is identically maintained during the first period and the second period.

A number of the second pixels is greater than a number of the first pixels.

The display area is a circular shape.

According to an embodiment, a display device includes a display panel that includes a display area and a plurality of pixels disposed in the display area and displays an image in a first mode or a second mode, a data driver that applies data voltages to the plurality of pixels, and a driving controller that controls driving of the data driver. The plurality of pixels includes valid pixels disposed in a valid area of the display area, and invalid pixels disposed in an invalid area of the display area, the first mode is a mode in which the display panel displays the image having a shape corresponding to the valid area and the invalid area, the second mode is a mode in which the display panel displays the image having a shape corresponding to the valid area, and while the display panel operates in the second mode, the invalid pixels display a black grayscale.

The display panel displays the image in units of a driving frame, and, during the driving frame, the data voltages are not applied to the invalid pixels.

The display panel displays the image during a dummy frame preceding the driving frame, and the data voltages applied to the invalid pixels during the dummy frame are dummy data.

The plurality of pixels includes first pixels arranged in a first direction, and second pixels arranged in the first direction and adjacent to the first pixels in a second direction intersecting the first direction. The driving frame includes a first period during which the data voltages are applied to the first pixels, and a second period during which the data voltages are applied to the second pixels, and a duration of the first period is shorter than a duration of the second period.

The plurality of pixels is connected to a plurality of channels, and a number of channels, through which the data voltages are applied to the plurality of pixels during the first period, from among the plurality of channels is smaller than a number of channels, through which the data voltages are applied to the plurality of pixels during the second period, from among the plurality of channels.

The plurality of channels includes first channels electrically connected to the first pixels and the second pixels, and second channels electrically connected to the second pixels. The data voltages are applied to the first pixels through the first channels during the first period, and the data voltages are applied to the second pixels through the first channels and the second channels during the second period.

According to an embodiment, an electronic device includes a display device that displays an image, and one or more processors that controls an operation of the display device. The display device includes a display panel that includes a plurality of pixels and displays the image in units of a driving frame, a data driver that applies data voltages to the plurality of pixels, and a driving controller that controls driving of the data driver. The plurality of pixels includes first pixels arranged in a first direction, and second pixels arranged in the first direction and adjacent to the first pixels in a second direction. The driving frame includes a first period during which the data voltages are applied to the first pixels, and a second period during which the data voltages are applied to the second pixels, and a duration of the first period is shorter than a duration of the second period.

### BRIEF DESCRIPTION OF THE FIGURES

The above and other features of the present disclosure will become apparent by describing in detail embodiments thereof with reference to the accompanying drawings.

FIG. 1 is a plan view of a display device according to an embodiment of the present disclosure.

FIG. 2 is a diagram illustrating a cross section of the display device illustrated in FIG. 1, according to an embodiment of the present disclosure.

FIG. 3 is a diagram illustrating a cross section of the display device illustrated in FIG. 2, according to an embodiment of the present disclosure.

FIG. 4 is a plan view of a display panel according to an embodiment of the present disclosure.

FIG. 5 is a block diagram of a data driver illustrated in FIG. 4, according to an embodiment of the present disclosure.

FIG. 6 is a block diagram of a display panel according to an embodiment of the present disclosure.

FIG. 7 is a timing diagram for describing an operation of a display panel according to an embodiment of the present disclosure.

FIG. 8 is an enlarged timing diagram of a first period, a second period, and a third period according to an embodiment of the present disclosure.

FIG. 9 is a plan view of a display device according to an embodiment of the present disclosure.

FIG. 10 is a diagram illustrating a display panel operating in a first mode, according to an embodiment of the present disclosure.

FIG. 11 is a diagram illustrating a display panel operating in a second mode, according to an embodiment of the present disclosure.

FIG. 12 is a timing diagram for describing an operation of a display panel according to an embodiment of the present disclosure.

FIG. 13 is a block diagram of an electronic device according to an embodiment.

FIG. 14 illustrates schematic views of electronic devices according to various embodiments.

### DETAILED DESCRIPTION

In the specification, the expression that a first component (or an area, a layer, a part, or a portion) is “on”, “connected to”, or “coupled to” a second component means that the first component is directly on/connected to/coupled to the second component or means that a third component is interposed therebetween.

The same reference numerals/signs refer to the same components. In addition, in drawings, thicknesses, proportions, and dimensions of components may be exaggerated to describe the technical features effectively. The expression “and/or” includes one or more combinations which associated components are capable of defining.

Even though the terms “first”, “second”, etc. may be used to describe various components, the components should not be construed as being limited by the terms. The terms are used only for the purpose of distinguishing one component, part, area, layer, or portion from another component, part, area, layer, or portion. For example, without departing from the scope of the present disclosure, a first component, a first part, a first area, a first layer, or a first portion may be named a second component, a second part, a second area, a second layer, or a second portion, and similarly, the second component, the second part, the second area, the second layer, or the second portion may be named the first component, the first part, the first area, the first layer, or the first portion. The articles “a”, “an”, and “the” are singular in that they have a single referent, but the use of the singular form should not preclude the presence of more than one referent.

Also, the terms “under”, “below”, “on”, “above”, etc. are used to describe the correlation of components illustrated in drawings. The terms that are relative in concept are described based on a direction shown in drawings.

It will be understood that the terms “include”, “comprise”, “have”, etc. specify the presence of features, numbers, steps, operations, elements, or components, described in the specification, or a combination thereof, not precluding the presence or additional possibility of one or more other features, numbers, steps, operations, elements, or components or a combination thereof.

Unless otherwise defined, all terms (including technical terms and scientific terms) used in the specification have the same meaning as commonly understood by one skilled in the art to which the present disclosure belongs. In addition, the terms such as terms defined in the dictionaries commonly used should be interpreted as having a meaning consistent with the meaning in the context of the related technology, and should not be interpreted in ideal or overly formal meanings unless explicitly defined herein.

Hereinafter, embodiments of the present disclosure will be described with reference to accompanying drawings.

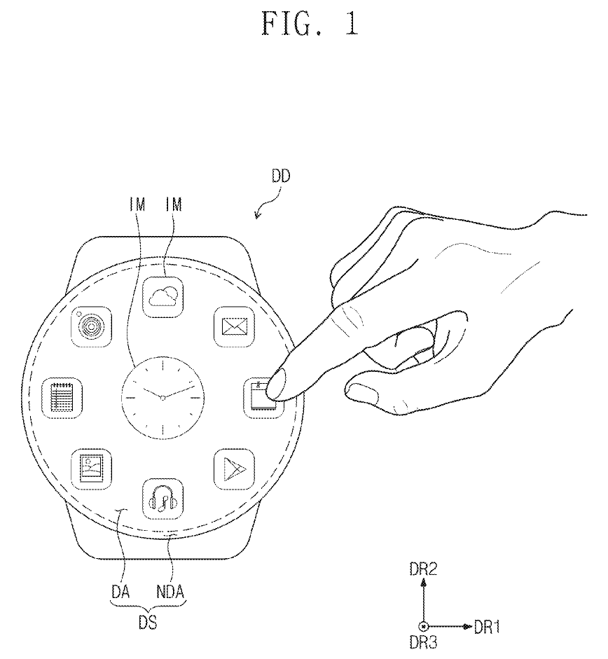

FIG. 1 is a plan view of a display device DD according to an embodiment of the present disclosure.

Referring to FIG. 1, the display device DD may be a device which is activated depending on an electrical signal. The display device DD may include various embodiments. For example, the display device DD may be applied to an electronic device such as a smart watch, a tablet PC, a notebook, a computer, or a smart television.

The display device DD may provide various images IM to the user. The images IM may indicate a time and various applications. For example, the display device DD may display the hour hand and the minute hand indicating a time so as to be provided to the user. Also, the display device DD may display various applications so as to be provided to the user.

The display device DD may be a touch-type display device. For example, when the user touches the applications displayed in the display device DD, the touched applications may be executed. For example, when the user touches an application associated with the weather from among the applications displayed in the display device DD, weather information may be provided to the user.

An upper surface of the display device DD may be defined as a display surface DS and may have a plane defined by a first direction DR1 and a second direction DR2. The first direction DR1 and the second direction DR2 may be defined as directions which vertically cross each other. The images IM generated by the display device DD may be provided to the user through the display surface DS.

Below, a direction which is substantially perpendicular to the plane defined by the first direction DR1 and the second direction DR2 is defined as a third direction DR3. Also, in the specification, the expression “when viewed from above a plane” may mean “when viewed in the third direction DR3”.

The display surface DS may include a display area DA and a non-display area NDA around the display area DA. The display area DA may display an image, and the non-display area NDA may not display an image. The non-display area NDA may surround the display area DA and may define a border of the display device DD printed with a given color.

When viewed from above a plane, the display device DD may be in the shape of a circle, but the present disclosure is not limited thereto. For example, the display device DD may be in the shape of a quadrangle, a polygon, or an oval.

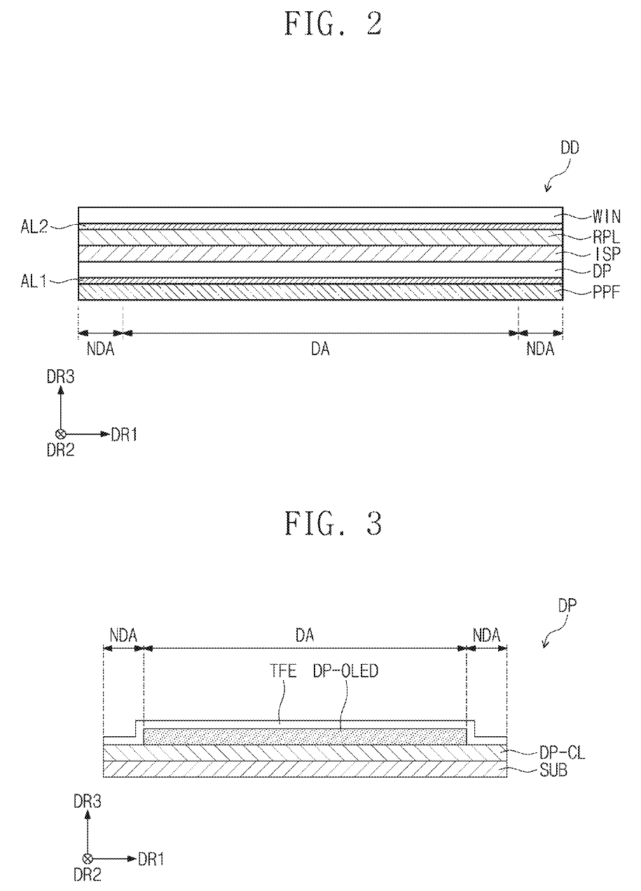

FIG. 2 is a diagram illustrating a cross section of the display device DD illustrated in FIG. 1, according to an embodiment of the present disclosure.

Referring to FIG. 2, the display device DD may include a display panel DP, an input sensing part ISP, a reflection preventing layer RPL, a window WIN, a panel protecting film PPF, a first adhesive layer AL1, and a second adhesive layer AL2.

The display panel DP may be a flexible display panel. The display panel DP according to an embodiment of the present disclosure may be a light emitting display panel, but is not particularly limited thereto. For example, the display panel DP may be an organic light emitting display panel or an inorganic light emitting display panel. An emissive layer of the organic light emitting display layer may include an organic light emitting material. An emissive layer of the inorganic light emitting display panel may include a quantum dot, a quantum rod, etc. Below, the description will be given under the condition that the display panel DP is an organic light emitting display panel.

The input sensing part ISP may be disposed on the display panel DP. The input sensing part ISP may include a plurality of sensing parts for sensing an external input in a capacitive manner. The input sensing part ISP may be manufactured directly on the display panel DP when the display device DD is manufactured. However, the present disclosure is not limited thereto. For example, the input sensing part ISP may be manufactured with a panel independent of the display panel DP and may then be attached to the display panel DP by an adhesive layer.

The reflection preventing layer RPL may be disposed on the input sensing part ISP. The reflection preventing layer RPL may be defined as a film for preventing an external light from being reflected. The reflection preventing layer RPL may reduce the reflectance of the external light incident to the display panel DP from above the display device DD.

When the external light traveling toward the display panel DP is reflected from the display panel DP and is again provided to an external user, like a mirror, the user may visually perceive the external light. To prevent the above phenomenon, in an embodiment, the reflection preventing layer RPL may include a plurality of color filters displaying the same colors as pixels of the display panel DP.

The color filters may filter the external light with the same colors as the pixels. In this case, the external light may not be visually perceived by the user. When the display device DD is manufactured, the reflection preventing layer RPL including the color filters may be manufactured directly on the input sensing part ISP.

In an embodiment, the reflection preventing layer RPL may include a polarization film including a retarder and/or a polarizer for the purpose of reducing the reflectance of the external light. The reflection preventing layer RPL including the polarization film may be manufactured with a panel independent of the input sensing part ISP and may then be attached to the input sensing part ISP by an adhesive layer.

The window WIN may be disposed on the reflection preventing layer RPL. The window WIN may protect the display panel DP, the input sensing part ISP, and the reflection preventing layer RPL from external scratches and impacts.

The panel protecting film PPF may be disposed under the display panel DP. The panel protecting film PPF may protect a bottom surface of the display panel DP. The panel protecting film PPF may include a flexible plastic material such as polyethylene terephthalate (PET).

The first adhesive layer AL1 may be interposed between the display panel DP and the panel protecting film PPF, and the display panel DP and the panel protecting film PPF may be bonded to each other by the first adhesive layer AL1. The second adhesive layer AL2 may be disposed between the reflection preventing layer RPL and the window WIN, and the reflection preventing layer RPL and the window WIN may be bonded to each other by the second adhesive layer AL2.

FIG. 3 is a diagram illustrating a cross section of the display panel DP illustrated in FIG. 2, according to an embodiment of the present disclosure.

Referring to FIG. 3, the display panel DP may include a substrate SUB, a circuit element layer DP-CL disposed on the substrate SUB, a display element layer DP-OLED disposed on the circuit element layer DP-CL, and a thin film encapsulation layer TFE disposed on the display element layer DP-OLED.

The substrate SUB may include the display area DA and the non-display area NDA around the display area DA. The substrate SUB may include a flexible plastic material such as glass or polyimide (PI). The display element layer DP-OLED may be disposed in the display area DA.

A plurality of pixels may be disposed in the circuit element layer DP-CL and the display element layer DP-OLED. Each of the pixels may include a transistor disposed in the circuit element layer DP-CL and a light emitting element disposed in the display element layer DP-OLED and connected to the transistor. A configuration of the pixel will be described in detail later.

The thin film encapsulation layer TFE may be disposed on the circuit element layer DP-CL so as to cover the display element layer DP-OLED. The thin film encapsulation layer TFE may protect pixels from moisture, oxygen, and foreign objects.

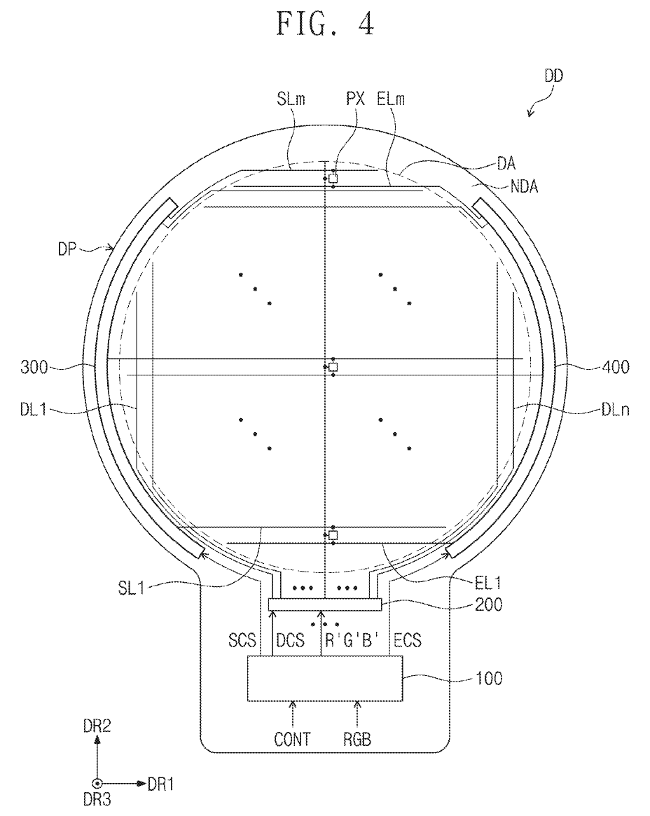

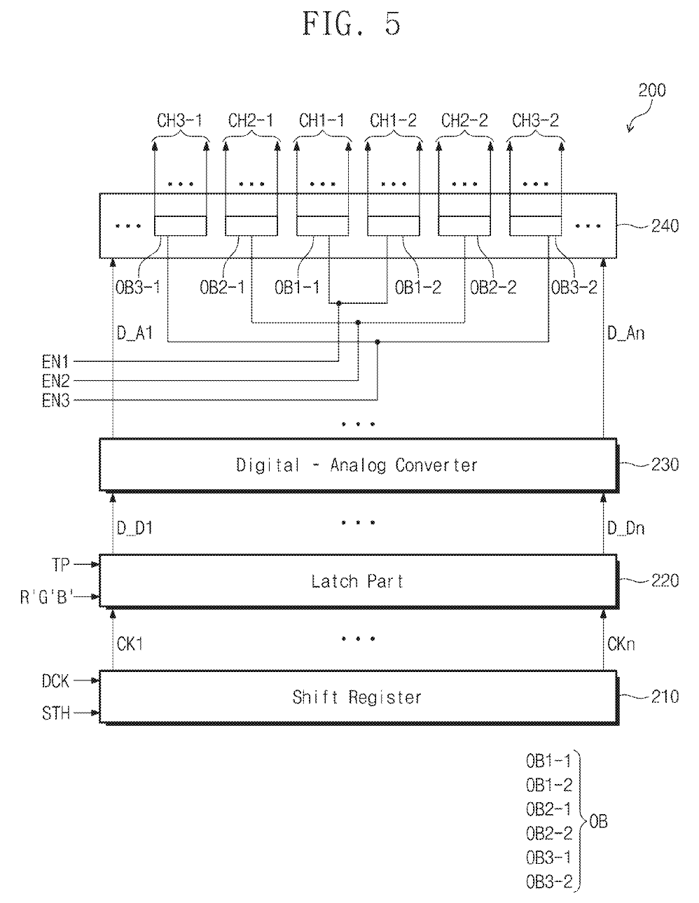

FIG. 4 is a plan view of the display device DD according to an embodiment of the present disclosure.

Referring to FIG. 4, the display device DD may include the display panel DP, a driving controller 100, a data driver 200, a scan driver 300, and an emission driver 400.

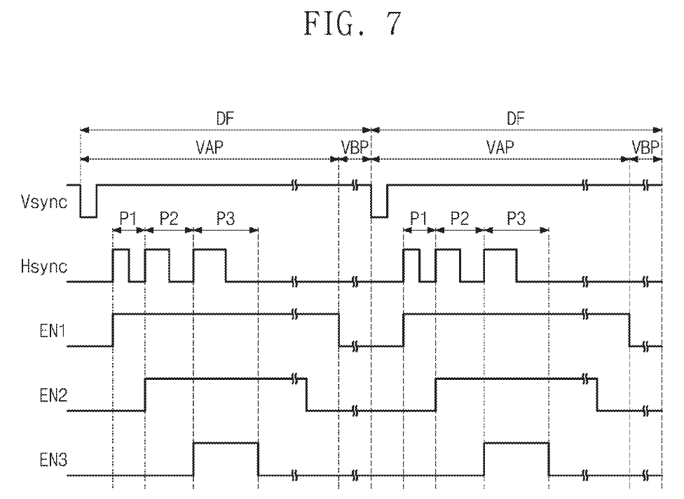

The driving controller 100 may control operations of the data driver 200, the scan driver 300, and the emission driver 400. The driving controller 100 may receive input image data RGB and an input control signal CONT from an external device (e.g., a host). The input image data RGB may include color information and grayscale information for each pixel PX. The input control signal CONT may include a main clock signal, a data enable signal, a vertical synchronization signal Vsync (refer to FIG. 7), and a horizontal synchronization signal Hsync (refer to FIG. 7).

The driving controller 100 may generate image data signals R’G’B’, a data control signal DCS, a scan control signal SCS, and an emission control signal ECS based on the input image data RGB and the input control signal CONT.

In detail, the driving controller 100 may generate the image data signals R’G’B’ based on the input image data RGB and may provide the image data signals R’G’B’ to the data driver 200. The image data signals R’G’B’ may be correction image data generated by correcting the input image data RGB. According to an embodiment, the driving controller 100 may perform the following on the input image data RGB: quality correction, spot correction, color characteristic correction, and/or active capacitance correction.

Also, the driving controller 100 may generate the data control signal DCS for controlling the operation of the data driver 200 based on the input control signal CONT and may provide the data control signal DCS to the data driver 200. The data control signal DCS may include a data clock signal, a data load signal, output control signals, etc. The driving controller 100 may generate the scan control signal SCS for controlling the operation of the scan driver 300 based on the input control signal CONT and may provide the scan control signal SCS to the scan driver 300. The scan control signal SCS may include a scan clock signal, etc. The driving controller 100 may generate the emission control signal ECS for controlling the operation of the emission driver 400 based on the input control signal CONT and may provide the emission control signal ECS to the emission driver 400. The emission control signal ECS may include an emission clock signal, etc.

An example in which the driving controller 100 is disposed at a lower end of the non-display area NDA is illustrated in FIG. 4, but the present disclosure is not limited thereto. For example, the display device DD may further include pads (not illustrated) disposed at the lower end of the non-display area NDA, a printed circuit board may be connected to the pads, and the driving controller 100 may be disposed on the printed circuit board. The driving controller 100 may be manufactured with an integrated circuit chip and may be mounted on the printed circuit board. The driving controller 100 may be connected to the pads through the printed circuit board.

The display panel DP may be in the shape of a circle, but the shape of the display panel DP is not limited thereto. In an embodiment, in the display panel DP having the circular shape, the lower end of the display panel DP may protrude toward the bottom to have a rectangular shape. The display panel DP may include the display area DA and the non-display area NDA around the display area DA. The display area DA may be in the shape of a circle. The non-display area NDA may surround the display area DA.

The display panel DP may include a plurality of pixels PX, a plurality of data lines DL1 to DLn, a plurality of scan lines SL1 to SLm, and a plurality of emission lines EL1 to ELm. In an embodiment, “m” and “n” are natural numbers.

The pixels PX may be disposed in the display area DA. The data driver 200 may be disposed in the non-display area NDA adjacent to one of opposite sides of the display panel DP, which face away from each other in the second direction DR2. When viewed from above a plane, the data driver 200 may be adjacent to the lower end of the display panel DP. The scan driver 300 and the emission driver 400 may be disposed in the non-display area NDA so as to be respectively adjacent to opposite sides of the display panel DP, which face away from each other in the first direction DR1. However, the present disclosure is not limited thereto. For example, the scan driver 300 and the emission driver 400 may be integrated into one driver.

The data lines DL1 to DLn may extend in the second direction DR2 and may be connected to the pixels PX and the data driver 200. The scan lines SL1 to SLm may extend in the first direction DR1 and may be connected to the pixels PX and the scan driver 300. The emission lines EL1 to ELm may extend in the first direction DR1 and may be connected to the pixels PX and the emission driver 400. The pixels PX may be disposed in regions partitioned by the scan lines SL1 to SLm, the data lines DL1 to DLn, and the emission lines EL1 to ELm.

The data driver 200 may generate a plurality of data voltages corresponding to the image data signals R’G’B’ in response to the data control signal DCS. The data voltages may be applied to the pixels PX through the data lines DL1 to DLn. The scan driver 300 may generate a plurality of scan signals in response to the scan control signal SCS. The scan signals may be applied to the pixels PX through the scan lines SL1 to SLm. The scan signals may be sequentially applied to the pixels PX. The emission driver 400 may generate a plurality of emission signals in response to the emission control signal ECS. The emission signals may be applied to the pixels PX through the emission lines EL1 to ELm.

The pixels PX may be provided with the data voltages in response to the scan signals. The pixels PX may display an image by emitting lights of luminance corresponding to the data voltages in response to the emission signals.

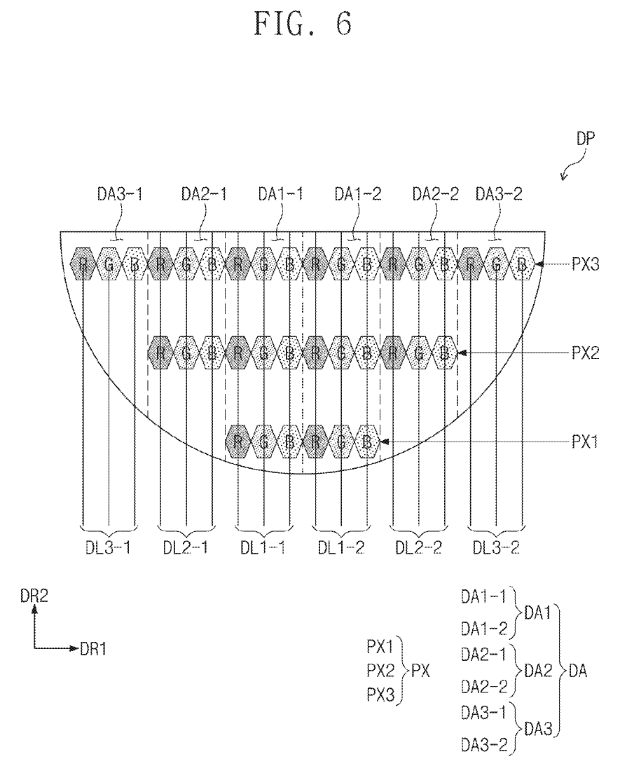

FIG. 5 is a block diagram of the data driver 200 illustrated in FIG. 4, according to an embodiment of the present disclosure.

Referring to FIGS. 4 and 5, the data driver 200 may include a shifter register 210, a latch part 220, a digital-analog converter 230, and an output buffer part 240.

The shifter register 210 may sequentially activate a plurality of latch clock signals CK1 to CKn based on a horizontal start signal STH and a data clock signal DCK. The horizontal start signal STH and the data clock signal DCK may be signals included in the data control signal DCS provided from the driving controller 100.

The latch part 220 may sequentially receive the image data signals R’G’B’ respectively corresponding to the pixels PX from the driving controller 100. The latch part 220 may latch the sequentially received image data signals R’G’B’ respectively in response to the latch clock signals CK1 to CKn provided from the shifter register 210. According to an embodiment, based on a data load signal TP, the latch part 220 may simultaneously output the latched image data signals R’G’B’ to the digital-analog converter 230 or may provide the latched image data signals R’G’B’ to the digital-analog converter 230 with a given time difference. The data load signal TP may be a signal included in the data control signal DCS. According to an embodiment, the latched image data signals R’G’B’ are defined as digital image signals D_D1 to D_Dn.

The digital-analog converter 230 may receive the digital image signals D_D1 to D_Dn from the latch part 220. The digital-analog converter 230 may convert the received digital image signals D_D1 to D_Dn into data voltages D_A1 to D_An of an analog form. Although not illustrated, the digital-analog converter 230 may be provided with a plurality of gamma voltages from the outside. The digital-analog converter 230 may output the data voltages D_A1 to D_An corresponding to the digital image signals D_D1 to D_Dn, based on the gamma voltages.

The data voltages D_A1 to D_An generated from the digital-analog converter 230 may be provided to the output buffer part 240. The output buffer part 240 may include a plurality of output blocks OB including one or more output buffers. For convenience of description, only six output blocks (referred to as (1-1)-th, (1-2)-th, (2-1)-th, (2-2)-th, (3-1)-th, and (3-2)-th output blocks OB1-1, OB1-2, OB2-1, OB2-2, OB3-1, and OB3-2) among the plurality of output blocks OB are illustrated in FIG. 5.

Each of the output blocks OB may be connected to k channels (k being an integer of 1 or more) to output data voltages through the channels. For example, the (1-1)-th output block OB1-1 may be connected to (1-1)-th channels CH1-1 and may apply data voltages to the (1-1)-th channels CH1-1, and the (1-2)-th output block OB1-2 may be connected to (1-2)-th channels CH1-2 and may apply data voltages to the (1-2)-th channels CH1-2. The (2-1)-th output block OB2-1 may be connected to (2-1)-th channels CH2-1 and may apply data voltages to the (2-1)-th channels CH2-1, and the (2-2)-th output block OB2-2 may be connected to (2-2)-th channels CH2-2 and may apply data voltages to the (2-2)-th channels CH2-2. The (3-1)-th output block OB3-1 may be connected to (3-1)-th channels CH3-1 and may apply data voltages to the (3-1)-th channels CH3-1, and the (3-2)-th output block OB3-2 may be connected to (3-2)-th channels CH3-2 and may apply data voltages to the (3-2)-th channels CH3-2. The output buffer part 240 may receive a plurality of enable signals. Only three enable signals (i.e., first to third enable signals EN1, EN2, and EN3) among the plurality of enable signals are illustrated in FIG. 5 as an example. The first enable signal EN1 may be applied to the (1-1)-th and (1-2)-th output blocks OB1-1 and OB1-2 to turn on or turn off the (1-1)-th and (1-2)-th output blocks OB1-1 and OB1-2. The second enable signal EN2 may be applied to the (2-1)-th and (2-2)-th output blocks OB2-1 and OB2-2 to turn on or turn off the (2-1)-th and (2-2)-th output blocks OB2-1 and OB2-2. The third enable signal EN3 may be applied to the (3-1)-th and (3-2)-th output blocks OB3-1 and OB3-2 to turn on or turn off the (3-1)-th and (3-2)-th output blocks OB3-1 and OB3-2. The first to third enable signals EN1, EN2, and EN3 will be described in detail later.

FIG. 6 is a block diagram of a display panel DP according to an embodiment of the present disclosure.

Referring to FIGS. 5 and 6, the plurality of pixels PX may be disposed in the display area DA. The plurality of pixels PX may be arranged in the first direction DR1 and the second direction DR2. A set of pixels arranged in the first direction DR1 from among the plurality of pixels PX may be referred to as a “pixel row”. Below, pixels included in a first pixel row disposed at the lowermost end of the display area DA may be referred to as “first pixels PX1”, pixels included in a second pixel row adjacent to the first pixels PX1 in the second direction DR2 may be referred to as “second pixels PX2”, and pixels included in a third pixel row adjacent to the second pixels PX2 in the second direction DR2 may be referred to as “third pixels PX3”. The second pixels PX2 may be disposed between the first pixels PX1 and the third pixels PX3 on the second direction DR2. For convenience of description, three pixel rows are illustrated in FIG. 6 as an example. However, the display panel DP may include a plurality of pixel rows interposed between the first pixels PX1 and the second pixels PX2, and may include a plurality of pixel rows interposed between the second pixels PX2 and the third pixels PX3. Also, in FIG. 6, the number of pixels included in each pixel row may differ by 6. However, the present disclosure is not limited thereto. For example, the number of pixels included in each pixel row may differ by 2, 4, 12, etc.

As an example of the present disclosure, the display area DA may be in the shape of a circle. Only a portion of the circular display area DA, in which the first to third pixels PX3 are disposed, is illustrated in FIG. 6 as an example. The display area DA may include a first display area DA1, a second display area DA2, and a third display area DA3. Each of the first to third display areas DA1 to DA3 may include two display areas symmetrical to each other with respect to a virtual central axis which penetrates a central point of the display area DA and is parallel to the second direction DR2. For example, the first display area DA1 may include a (1-1)-th display area DA1-1 and a (1-2)-th display area DA1-2 which are adjacent to each other with respect to the central axis. However, the present disclosure is not limited thereto. For example, the (1-1)-th display area DA1-1 and the (1-2)-th display area DA1-2 may be spaced apart from each other, and the plurality of pixels PX may be disposed between the (1-1)-th display area DA1-1 and the (1-2)-th display area DA1-2. The second display area DA2 may include a (2-1)-th display area DA2-1 and a (2-2)-th display area DA2-2 which are spaced apart from each other in the first direction DR1, with the first display area DA1 interposed therebetween. The third display area DA3 may include a (3-1)-th display area DA3-1 and a (3-2)-th display area DA3-2 which are spaced apart from each other in the first direction DR1, with the first display area DA1 and the second display area DA2 interposed therebetween.

Assuming that the display area DA is in the shape of a circle, the number of pixels included in a pixel row may decrease as a distance from the center of the display area DA increases in the second direction DR2. That is, the number of first pixels PX1 may be smaller than the number of second pixels PX2, and the number of second pixels PX2 may be smaller than the number of third pixels PX3.

The first pixels PX1 may be disposed in the first display area DA1, the second pixels PX2 may be disposed in the first display area DA1 and the second display area DA2, and the third pixels PX3 may be disposed in the first display area DA1, the second display area DA2, and the third display area DA3. That is, the first pixels PX1, some of the second pixels PX2, and some of the third pixels PX3 may be disposed in the first display area DA1. The others of the second pixels PX2 and others of the third pixels PX3 may be disposed in the second display area DA2. The others of the third pixels PX3 may be disposed in the third display area DA3.

The pixels PX disposed in the first display area DA1 may receive data voltages through (1-1)-th and (1-2)-th data lines DL1-1 and DL1-2 respectively connected to the (1-1)-th and the (1-2)-th channels CH1-1 and CH1-2 illustrated in FIG. 5. The pixels PX disposed in the second display area DA2 may receive data voltages through (2-1)-th and (2-2)-th data lines DL2-1 and DL2-2 respectively connected to the (2-1)-th and the (2-2)-th channels CH2-1 and 2-2 illustrated in FIG. 5. The pixels PX disposed in the third display area DA3 may receive data voltages through (3-1)-th and (3-2)-th data lines DL3-1 and DL3-2 respectively connected to the (3-1)-th and the (3-2)-th channels CH3-1 and CH3-2 illustrated in FIG. 5.

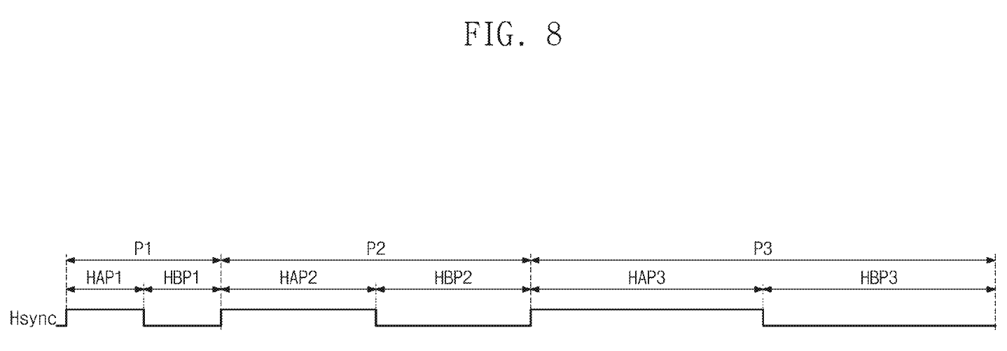

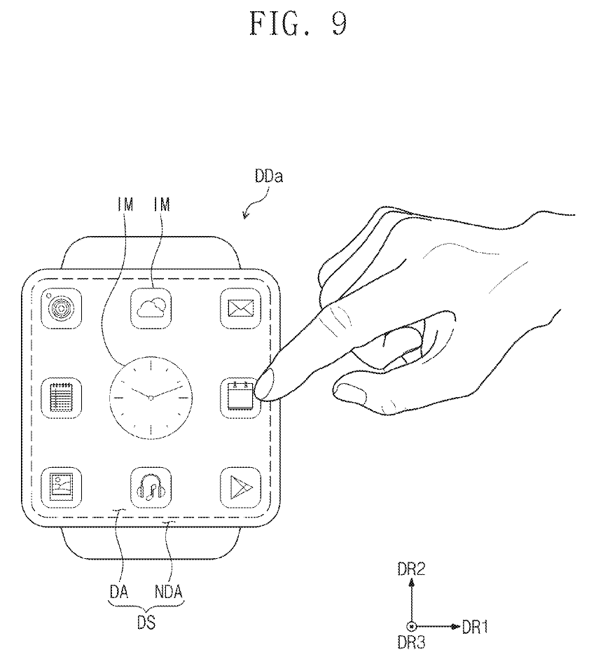

FIG. 7 is a timing diagram for describing an operation of a display panel according to an embodiment of the present disclosure. FIG. 8 is an enlarged timing diagram of a first period P1, a second period P2, and a third period P3 according to an embodiment of the present disclosure.

Referring to FIGS. 5, 6, and 7, the display panel DP may operate in units of driving frame DF. The driving frame DF may refer to a time unit by which the display panel DP displays an image. For example, when the driving frequency of the display panel DP is 60 Hz, 60 driving frames DF may be included per second, and a time corresponding to each of the driving frames DF may be about 16.67 ms. In an embodiment, when the driving frequency of the display panel DP is 120 Hz, 120 driving frames DF may be included per second, and a time corresponding to each of the driving frames DF may be about 8.3 ms. The period of each of the driving frames DF may be determined by the vertical synchronization signal Vsync. The vertical synchronization signal Vsync may be included in the input control signal CONT (refer to FIG. 4).

The driving frame DF may include a vertical driving period VAP and a vertical blank period VBP. During the vertical driving period VAP, the horizontal synchronization signal Hsync may be activated, and thus, data voltages may be output in units of pixel row. The horizontal synchronization signal Hsync may be included in the input control signal CONT (refer to FIG. 4). The vertical driving period VAP may include the first to third periods P1, P2, and P3. Each of the first to third periods P1, P2, and P3 may include an enable period and a disable period of the horizontal synchronization signal Hsync. Each of the first to third periods P1, P2, and P3 may correspond to the period of the horizontal synchronization signal Hsync. The enable period of the horizontal synchronization signal Hsync is defined as a high-level period of the horizontal synchronization signal Hsync, and the disable period of the horizontal synchronization signal Hsync is defined as a low-level period of the horizontal synchronization signal Hsync.

As an example of the present disclosure, when the horizontal synchronization signal Hsync is activated during the first to third periods P1 to P3, data voltages may be applied sequentially to respective pixel rows. An example in which the horizontal synchronization signal Hsync includes three enable periods during the vertical driving period VAP so as to correspond to the three pixel rows illustrated in FIG. 6 is illustrated in FIG. 7.

During the first period P1, the first enable signal EN1 may be activated, and the second enable signal EN2 and the third enable signal EN3 may be deactivated. The (1-1)-th and (1-2)-th output blocks OB1-1 and OB1-2 may be turned on in response to the first enable signal EN1 activated, and the (1-1)-th and (1-2)-th output blocks OB1-1 and OB1-2 turned on during the first period P1 may output data voltages to the (1-1)-th and (1-2)-th channels CH1-1 and CH1-2. The data voltages output to the (1-1)-th and (1-2)-th channels CH1-1 and CH1-2 during the first period P1 may be applied to the first pixels PX1 disposed in the first display area DA1. Because the second enable signal EN2 and the third enable signal EN3 are deactivated during the first period P1, the (2-1)-th, (2-2)-th, (3-1)-th, and (3-2)-th output blocks OB2-1, OB2-2, OB3-1, and OB3-2 may be turned off, and data voltages may not be applied to the (2-1)-th, (2-2)-th, (3-1)-th, and (3-2)-th channels CH2-1, CH2-2, CH3-1, and CH3-2. Because the first pixels PX1 are not disposed in the second display area DA2 and the third display area DA3, the (2-1)-th, (2-2)-th, (3-1)-th, and (3-2)-th output blocks OB2-1, OB2-2, OB3-1, and OB3-2 may be turned off during the first period P1, and thus, power consumption of the data driver 200 (refer to FIG. 4) may be reduced.

During the second period P2, the first enable signal EN1 and the second enable signal EN2 may be activated, and the third enable signal EN3 may be deactivated. The (1-1)-th, (1-2)-th, (2-1)-th, and (2-2)-th output blocks OB1-1, OB1-2, OB2-1, and OB2-2 may be turned on in response to the first and second enable signals EN1 and EN2 activated, and the (1-1)-th, (1-2)-th, (2-1)-th, and (2-2)-th output blocks OB1-1, OB1-2, OB2-1, and OB2-2 turned on during the second period P2 may output data voltages to the (1-1)-th, (1-2)-th, (2-1)-th, and (2-2)-th channels CH1-1, CH1-2, CH2-1, and CH2-2. The data voltages output to the (1-1)-th, (1-2)-th, (2-1)-th, and (2-2)-th channels CH1-1, CH1-2, CH2-1, and CH2-2 during the second period P2 may be applied to the second pixels PX2 disposed in the first display area DA1 and the second display area DA2. Since the third enable signal EN3 is deactivated during the second period P2, the (3-1)-th and (3-2)-th output blocks OB3-1 and OB3-2 may be turned off, and data voltages may not be applied to the (3-1)-th and (3-2)-th channels CH3-1 and CH3-2. Because the second pixels PX2 are not disposed in the third display area DA3, the (3-2)-th and (3-2)-th output blocks OB3-1 and OB3-2 may be turned off during the second period P2, and thus, power consumption of the data driver 200 (refer to FIG. 4) may be reduced.

During the third period P3, the first enable signal EN1, the second enable signal EN2, and the third enable signal EN3 may be activated. The (1-1)-th, (1-2)-th, (2-1)-th, (2-2)-th, (3-1)-th, and (3-2)-th output blocks OB1-1, OB1-2, OB2-1, OB2-2, OB3-1, and OB3-2 may be turned on in response to the first, second, and third enable signals EN1, EN2, and EN3 activated, and the (1-1)-th, (1-2)-th, (2-1)-th, (2-2)-th, (3-1)-th, and (3-2)-th output blocks OB1-1, OB1-2, OB2-1, OB2-2, OB3-1, and OB3-2 turned on during the third period P3 may output data voltages to the (1-1)-th, (1-2)-th, (2-1)-th, (2-2)-th, (3-1)-th, and (3-2)-th channels CH1-1, CH1-2, CH2-1, CH2-2, CH3-1, and CH3-2. The data voltages output to the (1-1)-th, (1-2)-th, (2-1)-th, (2-2)-th, (3-1)-th, and (3-2)-th channels CH1-1, CH1-2, CH2-1, CH2-2, CH3-1, and CH3-2 during the third period P3 may be applied to the third pixels PX3 disposed in the first display area DA1, the second display area DA2, and the third display area DA3.

The vertical blank period VBP may be followed by the vertical driving period VAP. The vertical blank period VBP, which is a period during which data voltages are not output, may be a period from after data voltages corresponding to a current driving frame DF are output until before data voltages corresponding to a next driving frame DF are output.

The number of output blocks activated during the first period P1 may be smaller than the number of output blocks activated during the second period P2, and the number of output blocks activated during the second period P2 may be smaller than the number of output blocks activated during the third period P3. In other words, the number of channels through which data voltages are applied to pixels during the first period P1 may be smaller than the number of channels through which data voltages are applied to pixels during the second period P2, and the number of channels through which data voltages are applied to pixels during the second period P2 may be smaller than the number of channels through which data voltages are applied to pixels during the third period P3. According to the present disclosure, data voltages are applied to the first pixels PX1 during the first period P1, but the first pixels PX1 are not disposed in the second display area DA2 and the third display area DA3. Accordingly, as output blocks corresponding to the second display area DA2 and the third display area DA3 are deactivated during the first period P1, data voltages may not be applied to pixels through channels connected to the deactivated output blocks. Also, data voltages are applied to the second pixels PX2 during the second period P2, but the second pixels PX2 are not disposed in the third display area DA3. Accordingly, as output blocks corresponding to the third display area DA3 are deactivated during the second period P2, data voltages may not be applied to pixels through channels connected to the deactivated output blocks. According to the above description, power consumption may be reduced.

The first period P1, the second period P2, and the third period P3 are enlarged and illustrated in FIG. 8. Referring to FIGS. 6, 7, and 8, the first period P1 may include a horizontal driving period HAP1 and a horizontal blank period HBP1, the second period P2 may include a horizontal driving period HAP2 and a horizontal blank period HBP2, and the third period P3 may include a horizontal driving period HAP3 and a horizontal blank period HBP3. In each of the horizontal driving periods HAP1, HAP2, and HAP3, data voltages may be applied to the pixels PX. Afterwards, the horizontal blank period HBP1/HBP2/HBP3 may be maintained before a next horizontal driving period starts. Each of the horizontal blank periods HBP1, HBP2, and HBP3 is a period during which data voltages are not applied to the pixels PX.

The first period P1 may include the first horizontal driving period HAP1 and the first horizontal blank period HBP1. During the first horizontal driving period HAP1, data voltages may be applied to the first pixels PX1 through the (1-1)-th and (1-2)-th data lines DL1-1 and DL1-2. The second period P2 may include the second horizontal driving period HAP2 and the second horizontal blank period HBP2. During the second horizontal driving period HAP2, data voltages may be applied to the second pixels PX2 through the (1-1)-th, (1-2)-th, (2-1)-th, and (2-2)-th data lines DL1-1, DL1-2, DL2-1, and DL2-2. The third period P3 may include the third horizontal driving period HAP3 and the third horizontal blank period HBP3. During the third horizontal driving period HAP3, data voltages may be applied to the third pixels PX3 through the (1-1)-th, (1-2)-th, (2-1)-th, (2-2)-th, (3-1)-th, and (3-2)-th data lines DL1-1, DL1-2, DL2-1, DL2-2, DL3-1, and DL3-2.

The duty ratio of the horizontal synchronization signal Hsync may be identically maintained during the first period P1, the second period P2, and the third period P3. As an example of the present disclosure, the duration of the horizontal driving period HAP1/HAP2/HAP3 may be identical to the duration of the horizontal blank period HBP1/HBP2/HBP3.

According to the present disclosure, the first period P1, the second period P2, and the third period P3 may have different durations. That is, the period of the horizontal synchronization signal Hsync may be variable during the vertical driving period VAP. The duration of the first period P1 may be shorter than the second period P2, and the duration of the second period P2 may be shorter than the duration of the third period P3. Also, the duration of the first horizontal driving period HAP1 may be shorter than the duration of the second horizontal driving period HAP2, and the duration of the second horizontal driving period HAP2 may be shorter than the duration of the third horizontal driving period HAP3.

Referring to FIGS. 4, 6, 7, and 8, together, data voltages may be applied to the first pixels PX1 during the first horizontal driving period HAP1, and data voltages may be applied to the second pixels PX2 during the second horizontal driving period HAP2. Because the number of first pixels PX1 is smaller than the number of second pixels PX2, the number of data to be applied to the first pixels PX1 during the first horizontal driving period HAP1 may be smaller than the number of data to be applied to the second pixels PX2 during the second horizontal driving period HAP2.

The data driver 200 may sequentially receive the image data signals R’G’B’ from the driving controller 100, and the data driver 200 may generate data voltages to be applied to the pixels PX based on the image data signals R’G’B’. That is, the image data signals R’G’B’ corresponding to data to be applied to the first pixels PX1 during the first period P1 may be sequentially applied to the data driver 200, and the image data signals R’G’B’ corresponding to data to be applied to the second pixels PX2 during the second period P2 may be sequentially applied to the data driver 200. As an example of the present disclosure, the image data signals R’G’B’ may be sequentially applied to the data driver 200 during the enable period of the horizontal synchronization signal Hsync. That is, the duration of the enable period of the horizontal synchronization signal Hsync may be set depending on the number of image data signals R’G’B’ to be applied to the data driver 200. However, the present disclosure is not limited thereto. For example, the image data signals R’G’B’ may be applied to the data driver 200 during a disable period preceding the enable period of the horizontal synchronization signal Hsync.

Because the number of data to be applied to the first pixels PX1 during the first period P1 is smaller than the number of data to be applied to the second pixels PX2 during the second period P2, the number of image data signals R’G’B’ which the data driver 200 receives during the first period P1 may be smaller than the number of image data signals R’G’B’ which the data driver 200 receives during the second period P2. Because the number of image data signals R’G’B’ which the data driver 200 receives during the first period P1 is smaller than the number of image data signals R’G’B’ which the data driver 200 receives during the second period P2, the duration of the first period P1 may be shorter than the duration of the second period P2. According to the above description, because unnecessary data are not transmitted, power consumption may be reduced.

FIG. 9 is a plan view of a display device according to an embodiment of the present disclosure.

Referring to FIG. 9, a display device DDa may be a device which is activated depending on an electrical signal. Because the display device DDa illustrated in FIG. 9 includes the same components except that the shape of the display device DDa is different from the shape of the display device DD illustrated in FIG. 1, and the same reference numerals/signs are used for the same components. Thus, additional description will be omitted to avoid redundancy. When viewed from above a plane, the appearance of the display device DDa is illustrated in FIG. 9 as being in the shape of a square.

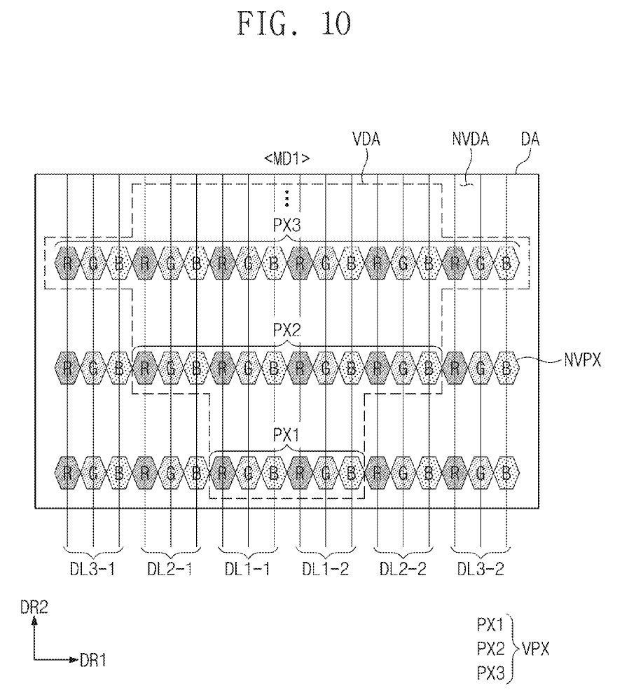

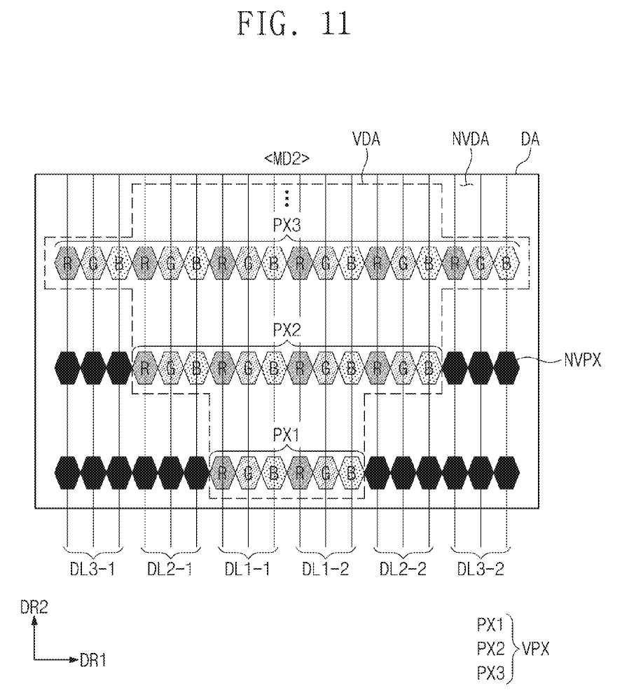

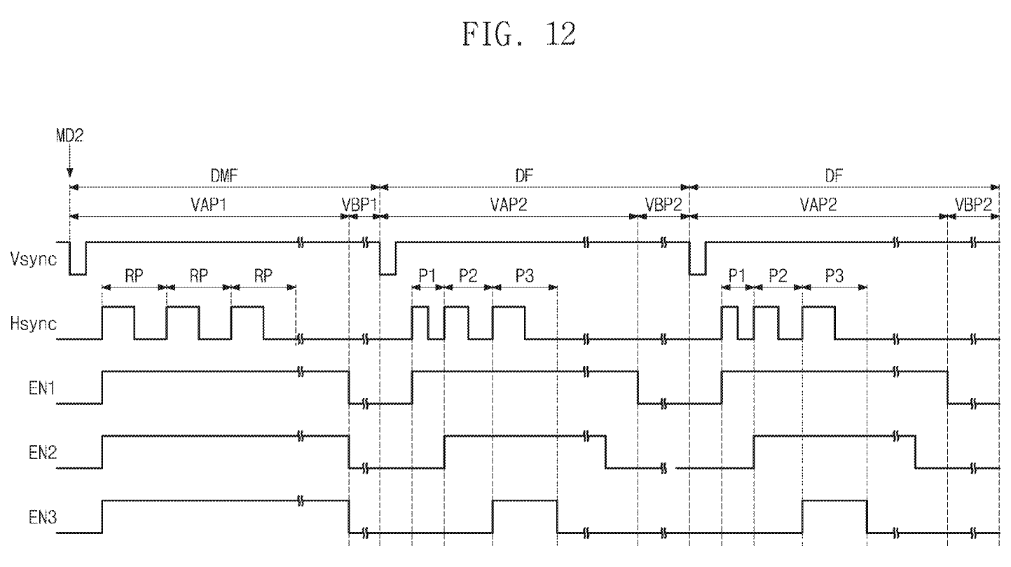

FIG. 10 is a diagram illustrating a display panel operating in a first mode, according to an embodiment of the present disclosure. FIG. 11 is a diagram illustrating a display panel operating in a second mode, according to an embodiment of the present disclosure.

Referring to FIGS. 10 and 11, the display area DA may display the image IM (refer to FIG. 1), and the display area DA may include a valid area VDA and an invalid area NVDA. The plurality of pixels PX may be disposed in the valid area VDA and the invalid area NVDA. Pixels disposed in the valid area VDA may be referred to as “valid pixels VPX”, and pixels disposed in the invalid area NVDA may be referred to as “invalid pixels NVPX”.

As an example of the present disclosure, the display panel DP may operate in a first mode MD1 or a second mode MD2. The first mode MD1 may refer to a mode in which the image IM (refer to FIG. 1) which the display panel DP displays has a shape corresponding to the valid area VDA and the invalid area NVDA. In the first mode MD1, each of the valid pixel VPX and the invalid pixel NVPX may emit a light depending on a data voltage corresponding to the image IM (refer to FIG. 3). The second mode MD2 may refer to a mode in which the image IM (refer to FIG. 2) which the display panel DP displays has a shape corresponding to the valid area VDA. In the second mode MD2, the valid pixel VPX may emit a light depending on a data voltage corresponding to the image IM (refer to FIG. 1), and the invalid pixel NVPX may emit a light of a black grayscale without displaying the image IM (refer to FIG. 1).

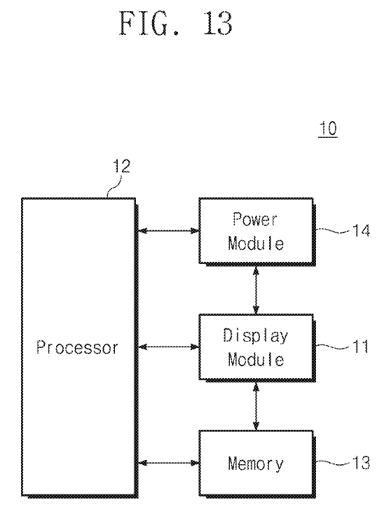

FIG. 12 is a timing diagram for describing an operation of a display panel according to an embodiment of the present disclosure.

Referring to FIGS. 10, 11, and 12, the display panel DP may operate in units of a dummy frame DMF and a plurality of the driving frames DF. The dummy frame DMF and two driving frames DF are illustrated in FIG. 12 as an example, but the present disclosure is not limited thereto. For example, the display panel DP may operate during the plurality of driving frames DF following the dummy frame DMF. The operation of the display panel DP in the driving frame DF is similar to the operation of the display panel DP in the driving frame DF described with reference to FIG. 7, and thus, additional description will be omitted to avoid redundancy.

The dummy frame DMF may precede the driving frame DF. The dummy frame DMF may be started at a time point at which the display panel DP starts to operate in the second mode MD2 after operating in the first mode MD1. The dummy frame DMF may include a first vertical driving period VAP1 and a first vertical blank period VBP1. The first vertical driving period VAP1 may include a plurality of reference periods RP. Each of the plurality of reference periods RP may include an enable period and a disable period of the horizontal synchronization signal Hsync. When the horizontal synchronization signal Hsync is activated, data voltages may be output in units of pixel row. Each of the plurality of reference periods RP may correspond to the period of the horizontal synchronization signal Hsync.

When the horizontal synchronization signal Hsync is activated during the plurality of reference periods RP, data voltages may be applied sequentially to respective pixel rows. An example in which the horizontal synchronization signal Hsync includes three enable periods during the first vertical driving period VAP1 so as to correspond to three pixel rows illustrated in FIGS. 10 and 11 is illustrated in FIG. 12.

During the first vertical driving period VAP1, the first, second, and third enable signals EN1, EN2, and EN3 may be activated. As an example of the present disclosure, the first, second, and third enable signals EN1, EN2, and EN3 may be activated during the plurality of reference periods RP. During the first vertical driving period VAP1, the enable periods of the first, second, and third enable signals EN1, EN2, and EN3 may have the same duration. The output blocks OB (refer to FIG. 5) may be turned on in response to the first, second, and third enable signals EN1, EN2, and EN3 activated during the plurality of reference periods RP, and data voltages may be output to the channels CH1-1, CH1-2, CH2-1, CH2-2, CH3-1, and CH3-2. The data voltages output to the channels CH1-1, CH1-2, CH2-1, CH2-2, CH3-1, and CH3-2 during the reference period RP may be applied to the valid pixels VPX disposed in the valid area VDA and the invalid pixels NVPX disposed in the invalid area NVDA. Herein, the data voltages applied to the pixels disposed in the invalid area NVDA may be voltages based on dummy data, and the dummy data may be used to express a black grayscale.

The first vertical blank period VBP1 may progress after the first vertical driving period VAP1. The first vertical blank period VBP1, which is a period during which data voltages are not output, may be a period from after data voltages corresponding to the dummy frame DMF are output until before data voltages corresponding to a next driving frame DF are output.

The driving frame DF may follow the dummy frame DMF. The driving frame DF may include a second vertical driving period VAP2 and a second vertical blank period VBP2. The second vertical driving period VAP2 and the second vertical blank period VBP2 illustrated in FIG. 12 are similar to the vertical driving period VAP and the vertical blank period VBP illustrated in FIG. 7, and thus, additional description will be omitted to avoid redundancy. During the driving frame DF, data voltages may be applied to the valid pixels VPX, and data voltages may not be applied to the invalid pixels NVPX. During the driving frame DF, no new data voltage is applied to the invalid pixels NVPX, so that the dummy data applied to the invalid pixels NVPX during the dummy frame DMF is maintained to display a black gray level. The duration of each of the plurality of reference periods RP belonging to the first vertical driving period VAP1 may be identical to the duration of the third period P3 belonging to the second vertical driving period VAP2. Because the invalid pixels NVPX are not disposed at a pixel row where the third pixels PX3 are disposed, the duration of the third period P3 may be identical to the duration of each of the plurality of reference periods RP.

As an example of the present disclosure, the duration of each of the first and second periods P1 and P2 may be shorter than the duration of each of the plurality of reference periods RP. According to the above description, the duration of the second horizontal driving period VAP2 may be shorter than the duration of the first vertical driving period VAP1, and the duration of the second vertical blank period VBP2 may be longer than the duration of the first vertical blank period VBP1. The period during which the horizontal synchronization signal Hsync is activated may decrease in the driving frame DF, and thus, power consumption may be reduced.

According to the present disclosure, when the shape of the display area DA is different from the shape of the image IM (refer to FIG. 1), the invalid area NVDA in which the image IM (refer to FIG. 1) is not displayed may be included in the display area DA. While the image IM (refer to FIG. 1) is displayed, data voltages may not be applied to the invalid pixels NVPX disposed in the invalid area NVDA, and data voltages may be applied to the valid pixels VPX disposed in the valid area VDA substantially corresponding to the image IM (refer to FIG. 1). Accordingly, power consumption may be reduced.

A display device according to an embodiment may be applied to various electronic devices. An electronic device according to an embodiment may include the display device described above and may further include a module or device, which provides any other additional functions, in addition to the display device.

FIG. 13 is a block diagram of an electronic device 10 according to an embodiment. Referring to FIG. 13, the electronic device 10 according to an embodiment may include a display module 11, a processor 12, a memory 13, and a power module 14.

The processor 12 may include one or more processors and may include at least one of a central processing unit (CPU), an application processor (AP), a graphic processing unit (GPU), a communication processor (CP), an image signal processor (ISP), and a controller. The processor 12 may control operations of a display device according to embodiments of the present disclosure.

Data information necessary for operations of the processor 12 or the display module 11 may be stored in the memory 13. When the processor 12 executes an application stored in the memory 13, an image data signal and/or an input control signal may be transferred to the display module 11, and the display module 11 may process the provided signal and may output image information through a display screen.

The power module 14 may include a power supply module such as a power adapter or a battery device and a power conversion module which converts the power supplied by the power supply module to generate the power necessary for operations of the electronic device 10.

The electronic device 10 may include the display device according to the above embodiments, and at least one of the components of the electronic device 10 may be included in the display device. In addition, some of individual modules functionally included in one module may be included in the display device, and the others may be provided independently of the display device. For example, the display device may include the display module 11, and the processor 12, the memory 13, and the power module 14 may be provided in the form of other devices in the electronic device 10 rather than the display device.

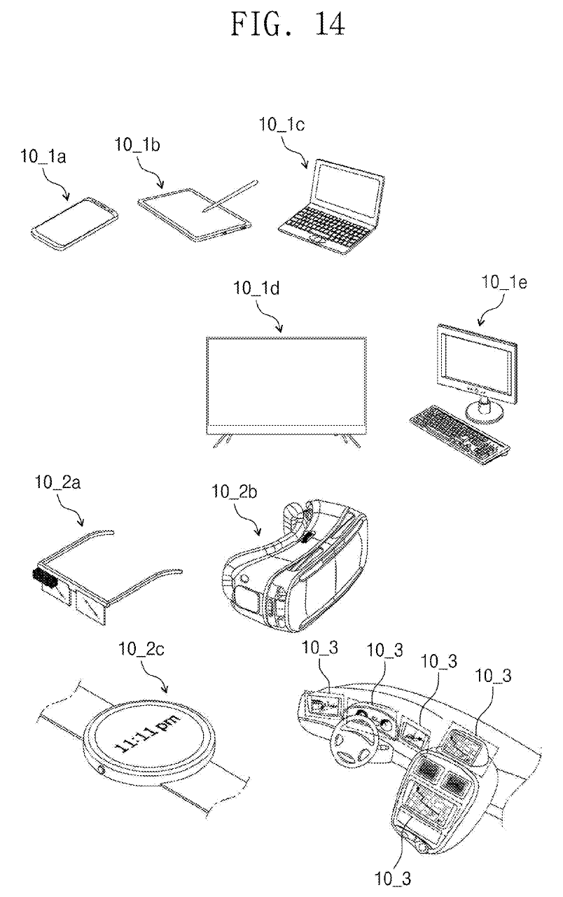

FIG. 14 illustrates schematic views of electronic devices according to various embodiments.

Referring to FIG. 14, various electronic devices to which the display device according to the embodiments is applied may include electronic devices for displaying images, such as a smartphone 10_1a, a tablet PC 10_1b, a laptop 10_1c, a TV 10_1d, and a desk monitor 10_1e, wearable electronic devices each including a display module, such as smart glasses 10_2a, a head mounted display 10_2b, and a smart watch 10_2c, and automotive electronic devices 10_3 each including a display module for a vehicle, such as an instrument panel, a center fascia, a center information display (CID) disposed on a dashboard, and a room mirror display.

A display panel may include a plurality of pixels, a plurality of pixel rows may be arranged in a first direction, and the plurality of pixels may be disposed in units of pixel row. While a horizontal synchronization signal is activated, each of the plurality of pixel rows may receive data voltages from a data driver. According to the present disclosure, the period of the horizontal synchronization signal may be differently set depending on the number of pixels activated for each pixel row. That is, when the number of pixels activated for each pixel row decreases, the number of data applied to the pixel row may decrease, and the period of the horizontal synchronization signal may become shorter. As described above, when a pixel row includes a pixel(s) which is deactivated, unnecessary data may not be transmitted, and thus, power consumption may be reduced.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A display device comprising:
a display panel including a plurality of pixels, and configured to display an image in units of a driving frame;
a data driver configured to apply data voltages to the plurality of pixels; and
a driving controller configured to control driving of the data driver,
wherein the plurality of pixels includes:
first pixels arranged in a first direction; and
second pixels arranged in the first direction and adjacent to the first pixels in a second direction intersecting the first direction,
wherein the driving frame includes:
a first period during which the data voltages are applied to the first pixels; and
a second period during which the data voltages are applied to the second pixels, and
wherein a duration of the first period is shorter than a duration of the second period.

2. The display device of claim 1, wherein the plurality of pixels is electrically connected to a plurality of channels, and
wherein a number of channels, through which the data voltages are applied to the plurality of pixels during the first period, from among the plurality of channels is smaller than a number of channels, through which the data voltages are applied to the plurality of pixels during the second period, from among the plurality of channels.

3. The display device of claim 2, wherein the plurality of channels includes:
first channels electrically connected to the first pixels and a portion of the second pixels; and
second channels electrically connected to a remaining portion of the second pixels,
wherein the data voltages are applied to the first pixels through the first channels during the first period, and
wherein the data voltages are applied to the second pixels through the first channels and the second channels during the second period.

4. The display device of claim 3, wherein the data driver includes a plurality of output blocks,
wherein the first channels are connected to a first output block among the plurality of output blocks, and
wherein the second channels are connected to a second output block among the plurality of output blocks.

5. The display device of claim 4, wherein, during the first period and the second period, the first output block is turned on in response to a first enable signal, and
wherein, during the second period, the second output block is turned on in response to a second enable signal.

6. The display device of claim 5, wherein the data driver includes:
a latch part configured to receive an image data signal from the driving controller and to latch the image data signal;
a digital-analog converter configured to convert the image data signal into the data voltages; and
an output buffer part configured to output the data voltages, and
wherein the output buffer part includes the plurality of output blocks.

7. The display device of claim 4, wherein the display panel includes a display area in which the plurality of pixels is disposed, and
wherein the display area includes:
a first display area in which the first pixels and the portion of the second pixels are disposed; and
a second display area in which the remaining portion of the second pixels are disposed.

8. The display device of claim 7, wherein the data voltages are applied to the plurality of pixels disposed in the first display area through the first channels, and
wherein the data voltages are applied to the plurality of pixels disposed in the second display area through the first channels and the second channels.

9. The display device of claim 1, wherein the driving controller receives an input control signal including a vertical synchronization signal and a horizontal synchronization signal,
wherein the vertical synchronization signal determines a period of the driving frame, and
wherein the horizontal synchronization signal determines enable time points of the first period and the second period.

10. The display device of claim 9, wherein a period of the horizontal synchronization signal is variable during the driving frame.

11. The display device of claim 9, wherein a duty ratio of the horizontal synchronization signal is identically maintained during the first period and the second period.

12. The display device of claim 1, wherein a number of the second pixels is greater than a number of the first pixels.

13. The display device of claim 1, wherein the display area is a circular shape.

14. A display device comprising:
a display panel including a display area and a plurality of pixels disposed in the display area, and configured to display an image in a first mode or a second mode;
a data driver configured to apply data voltages to the plurality of pixels; and
a driving controller configured to control driving of the data driver,
wherein the plurality of pixels includes:
valid pixels disposed in a valid area of the display area; and
invalid pixels disposed in an invalid area of the display area,
wherein the first mode is a mode in which the display panel displays the image having a shape corresponding to the valid area and the invalid area,
wherein the second mode is a mode in which the display panel displays the image having a shape corresponding to the valid area, and
wherein, while the display panel operates in the second mode, the invalid pixels display a black grayscale.

15. The display device of claim 14, wherein the display panel displays the image in units of a driving frame, and
wherein, during the driving frame, the data voltages are not applied to the invalid pixels.

16. The display device of claim 15, wherein the display panel displays the image during a dummy frame preceding the driving frame, and
wherein the data voltages applied to the invalid pixels during the dummy frame are dummy data.

17. The display device of claim 14, wherein the plurality of pixels includes:
first pixels arranged in a first direction; and
second pixels arranged in the first direction and adjacent to the first pixels in a second direction intersecting the first direction,
wherein the driving frame includes:
a first period during which the data voltages are applied to the first pixels; and
a second period during which the data voltages are applied to the second pixels, and
wherein a duration of the first period is shorter than a duration of the second period.

18. The display device of claim 17, wherein the plurality of pixels is connected to a plurality of channels, and
wherein a number of channels, through which the data voltages are applied to the plurality of pixels during the first period, from among the plurality of channels is smaller than a number of channels, through which the data voltages are applied to the plurality of pixels during the second period, from among the plurality of channels.

19. The display device of claim 18, wherein the plurality of channels includes:
first channels electrically connected to the first pixels and the second pixels; and
second channels electrically connected to the second pixels,
wherein the data voltages are applied to the first pixels through the first channels during the first period, and
wherein the data voltages are applied to the second pixels through the first channels and the second channels during the second period.

20. An electronic device comprising:
a display device configured to display an image; and
one or more processors configured to control an operation of the display device,
wherein the display device includes:
a display panel including a plurality of pixels, and configured to display the image in units of a driving frame;
a data driver configured to apply data voltages to the plurality of pixels; and
a driving controller configured to control driving of the data driver,
wherein the plurality of pixels includes:
first pixels arranged in a first direction; and
second pixels arranged in the first direction and adjacent to the first pixels in a second direction,
wherein the driving frame includes:
a first period during which the data voltages are applied to the first pixels; and
a second period during which the data voltages are applied to the second pixels, and
wherein a duration of the first period is shorter than a duration of the second period.
